(19) United States
(12) Patent Application Publication
(10) Pub. No.: US 2008/0123844 A1
(43) Pub. Date: May 29, 2008

(54) METHOD FOR REALIZING PREVIEW OF IPTV PROGRAMS, AN ENCRYPTION APPARATUS, A RIGHT CENTER SYSTEM AND A USER TERMINAL

(76) Inventor: Chao SUN, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/956,038

(22) Filed: Dec. 13, 2007

Related U.S. Application Data
(63) Continuation of application No. PCT/CN2006/002555, filed on Sep. 28, 2006.

(30) Foreign Application Priority Data
Sep. 28, 2005 (CN) 200510105477.7

(51) Int. Cl. H04N 7/167

(52) U.S. Cl. 380/200

(57) ABSTRACT

A method for implementing preview of IPTV programs, an encryption apparatus, a right center system and a user terminal are provided. The preview groups are set up in the Digital Right Management DRM system; DRM system generates the group authorization information for the terminal according to the preview groups, and sends it to the terminal; the terminal obtains the Content Encrypt Key CEK or the seeds which generation the CEK, of the selected preview program in the corresponding preview group according to the received group authorization information, and decrypts the selected program, so as to preview the program. The prior authorization of program group can be realized using the method according to the invention; as a result, not only the concurrent access numbers to the right center can be reduced to improve the reliability of the system but also the users' waiting time can be reduced to improve the users' experience; further, the preview rules which can be arranged provide flexible business running method for providers, i.e. several programs with the same preview rule can be packed to be distributed.

The present application is a continuation of PCT application PCT/CN2006/002555, filed on Sep. 28, 2006, entitled “A METHOD FOR REALIZING PREVIEW OF IPTV PROGRAMS, AN ENCRYPTION APPARATUS, A RIGHT CENTER SYSTEM AND A USER TERMINAL”, which is incorporated by reference herein in its entirety.

### FIELD OF THE INVENTION

The present invention relates to the field of network communication technology, and particularly to a method for implementing preview of IPTV programs, an encryption apparatus, a right center system and a user terminal.

### BACKGROUND OF THE INVENTION

In today's IPTV service provision process, usually the program preview function is implemented through the Media Distribute Network (MDN). The method is implemented as follows: Program fragments are extracted to compose new programs, and the programs are previewed on the subscriber's request.

However, the above technical scheme has the following drawbacks: since the program fragments can only be abstracted to compose new preview programs through MDN on the premise that the programs are not encrypted, this method can't be used to implement preview of encrypted programs; furthermore, if the previewed programs are not encrypted, it is difficult to ensure security of the programs; and if the preview programs are to be encrypted, the extracted program fragments have to be encrypted again by an encryption unit, which results in complex processing.

As more and more stream media are transmitted over the network, a new technique which is called Digital Right Management (DRM) is developed. By using the DRM, not only the digital contents are protected, but also program preview and batch ordering services can be deployed.

Therefore, with emerging of the DRM technique, a method for implementing preview of IPTV programs occurs. The method is implemented by means of providing preview authorization to a user terminal on the basis of a DRM system.

Specifically, the method is implemented as follows: A first level encryption is executed for the program to be previewed, and the Content Encrypt Key (CEK) of the program is carried in the preview right, which also carries information of the accumulated time of previews which is permitted, number of previews, and validity period, etc. After a user terminal initiated a preview request and registered with the right center, the right center dispatches the right of corresponding program to be previewed to the terminal. The terminal obtains a CEK of the program through the right information, decrypts the program content, and plays the program for the user to preview. When the playing time of the program approaches the accumulated time of preview specified in the preview right, the preview right will become invalid, and the program preview is refused.

Though the above technical scheme can implement preview of encrypted programs and cut the secondary encryption process, it is obvious that the technical scheme has the following drawbacks:

1. It severely increases the concurrent traffic of visits to the right center and degrades the system reliability. The preview function is usually free of charge to users, and users are accustomed to choose a program to be watched with certain charge by previewing among a vast amount of programs. However, for each preview operation, a preview right is required to be dispatched from the right center; as a result, when a large number of users choose programs, they put a high requirement on processing capacity of the right center.

2. Since a preview right application process is required whenever a program is to be previewed, the subscriber has to wait for a long time which leads to a poor experience.

### SUMMARY OF THE INVENTION

In view of the drawbacks in the prior art, an embodiment of the invention provides a method for implementing preview of programs, which implements pre-authorization for batch programs, reduces concurrent traffic of visits to the right center, and enhances system reliability.

The object of the present invention is implemented with the following technical scheme:

A method for implementing preview of IPTV programs includes:

configuring at least one preview group in a Digital Right Management (DRM) system, each preview group corresponding to at least one preview program;

generating, by the DRM system, group authorization information for a terminal according to the preview group, and dispatching the group authorization information to the terminal;

obtaining, by the terminal, a Content Encrypt Key (CEK) or a CEK generation seed for a preview program chosen by the terminal in the corresponding preview group according to the received group authorization information, and decrypting the program chosen by the terminal to implement program preview.

The technical scheme of the following method is an optional technical scheme.

The preview group is created according to a preview rule and has a corresponding Group Encrypt Key (GEK) or GEK obtaining ways. The method includes:

encrypting, by utilizing the GEK, the CEK or the CEK generation seed for each of the preview programs in the preview group, the encrypted information being carried in media description information or a media package of the preview program.

when an encryption algorithm for encrypting the CEK or the CEK generation seed for each of the preview programs in the preview group is the symmetric cryptographic algorithm, the decryption key for decrypting the CEK or the CEK generation seed for each of the preview programs in the preview group is the GEK of the preview group.

The encrypted information of the CEK or CEK generation seed for each of the preview programs is carried in a content key parameter in the media description information for the preview programs or carried in an additional segment of the media package for the preview programs.

The process that the group authorization information is generated and dispatched includes:

when a terminal completes a registration with a right center, requesting, by the terminal, the right center to dispatch the group authorization information of the preview group that has not stored locally, according to the electronic program guide (EPG) notification; generating, by the right center, the corresponding group authorization information, and dispatching it to the terminal; storing, by the terminal, the group authorization information; or,

after the terminal chooses a preview program but has not stored the group authorization information of the preview group which the program belongs to, requesting, by the terminal, the right center to dispatch the corresponding group authorization information, according to a Group ID of the preview group carried in the media description information of the program; generating, by the right center, the corresponding group authorization information, and dispatching it to the terminal; storing, by the terminal, the group authorization information.

The group authorization information includes:

a Group ID of the preview group, a preview rule, a decryption key for the CEK or the CEK generation seed for a preview program or a decryption key obtaining method, and decryption algorithm information.

The process of decrypting the preview programs to implement program preview includes:

after a terminal chose a preview program in the preview group, determining, by the terminal, the corresponding group authorization information stored in the terminal, according to the Group ID carried in the media description information of the program which is dispatched by a media server, and obtaining a decryption key and decryption algorithm information for the CEK or the CEK generation seed of the preview program;

decrypting, by the terminal, the encrypted CEK or the CEK generation seed carried in the media description information or the additional segment of the media package for the preview programs, according to the obtained decryption key and decryption algorithm information, to obtain the CEK or the CEK generation seed for the preview program;

decrypting, by a Digital Right Management Agent (DRM Agent) in the terminal, each media package of the preview program, according to the obtained CEK or the CEK generation seed of the preview program, so as to implement program preview.

The method further includes:

when an encrypt machine encrypts the content of a preview program, creating an additional segment for the media package of the preview program, and setting, in the additional segment, the current stage identification of the preview program and the control information of the program, according to a preview rule of the preview program; and the process for implementing the program preview including:

when the DRM Agent in a terminal determines to permit the terminal to preview a program in accordance with the stage identification and the control information in the additional segment, decrypting, by the DRM Agent, each media package of the preview program, by utilizing the CEK or the CEK generation seed for the preview program, so as to implement program preview;

The stage identification includes an identification for a program-previewable stage or an identification for a program-non-previewable stage and the control information is a restriction condition on decrypting a media package by a terminal.

The method includes: verifying, by a terminal, integrity of the stage identification and control information in the additional segment, according to a signature key in the media description information of the program dispatched by the media server.

The method further includes:

after the DRM Agent in a terminal determines the stage identification carried in the additional segment of the media package for the preview program is an identification for a program-non-previewable stage, implementing, by the terminal, the program subscription, according to the Content ID of the program.

An encryption apparatus for implementing preview of IPTV programs includes:

a storage module for storing at least one preview group, each preview group corresponding to at least one preview program and a Group Encryption Key (GEK) or GEK obtaining ways;

an encryption module for encrypting a preview program by utilizing a CEK of each of the preview programs and then outputting the encrypted preview program, and encrypting a CEK or CEK generation seed for each of the preview programs in a preview group by utilizing the GEK and then outputting the encrypted CEK or CEK generation seed.

The following technical scheme of the encryption apparatus is an optional technical scheme.

The information of the CEK or CEK generation seed encrypted by the encryption module for each of the preview programs is carried in media description information or media package of the preview program.

The encryption module creates an additional segment for a media package of a preview program, and sets, in the additional segment, the current stage identification of the preview program and the control information of the program, according to a preview rule of the preview program;

The stage identification includes an identification for a program-previewable stage and an identification for a program-non-previewable stage and the control information is a restriction condition on decrypting a media package by a terminal.

A right center system arranged with a group authorization device is further provided in the present invention.

The group authorization device is configured to generate group authorization information for a preview group for terminals and dispatch the group authorization information to the terminals, such that each of the terminals obtains a CEK or a CEK generation seed for each of the preview programs according to the group authorization information.

A user terminal device is further provided according to the invention, including:

a key obtaining module for obtaining a Content Encryption Key (CEK) or a CEK generation seed for a preview program chosen by a terminal from a corresponding preview group according to group authorization information received by the terminal and the key-related information in the media description information of the program, and transmitting the CEK or CEK generation seed to a decryption module;

a decryption module for decrypting a preview program chosen by a user terminal according to the received CEK or the CEK generation seed, so as to implement program preview.

The user terminal device is further arranged with a key management module.

The key management module is configured to request, according to an Electronic Program Guide (EPG) notification, a right center to dispatch the group authorization information of the preview group that has not been stored by the terminal after the terminal finishes a registration with the right center, and receive and store the group authorization information dispatched from the right center; or, after the terminal chose a preview program and it has not stored the group authorization information of the preview group which the program belongs to, the key management module requests the right center to dispatch the corresponding group authorization information according to a Group ID of the preview group carried in the media description information of the program, and receives and stores the group authorization information dispatched from the right center.

It can be seen from the technical scheme provided in the invention as described above that the method provided in the present invention has the following advantages:

1. It can implement pre-authorization for batch programs, reduce concurrent traffic of visits to the right center, and enhance system reliability.

2. Since the pre-authorization for batch programs is achieved, it is helpful to reduce the number of requesting the right center to dispatch the preview right, and thereby reduces waiting time for a user and improves user's experience.

3. The configurable preview rules provide a flexible service operation method for the operators, for example, multiple programs with the same preview rule can be sold in package.

4. According to the present invention, it doesn't change the structures of existing devices and is compatible with existing devices.

### BRIEF DESCRIPTION OF THE DRAWINGS

FIG. 1 is a flow diagram for implementing preview of IPTV programs according to an embodiment of the invention.

### DETAILED DESCRIPTION OF THE EMBODIMENTS

The major technical scheme of the invention is as follows: one or more preview groups are configured in a Digital Right Management (DRM) system, each preview group corresponding to one or more programs permitted to be previewed. Group authorization information is generated for a terminal according to a preview group and is dispatched to the terminal. The terminal obtains a Content Encrypt Key (CEK) or a seed of the CEK for a preview program chosen from a corresponding preview group by the terminal according to group authorization information received by the terminal and the key-related information in the media description information of the program and decrypts the preview program chosen by the terminal, so as to implement program preview.

A prerequisite for implementing the technical scheme of the present invention is that the CEK or the CEK generation seed for a preview program is constant, i.e., in the entire program playing process, a terminal obtains a CEK with an algorithm by using a random but constant value.

In order to make the present invention understood better, the method provided in the invention will be described in detail, with reference to the accompanying drawings.

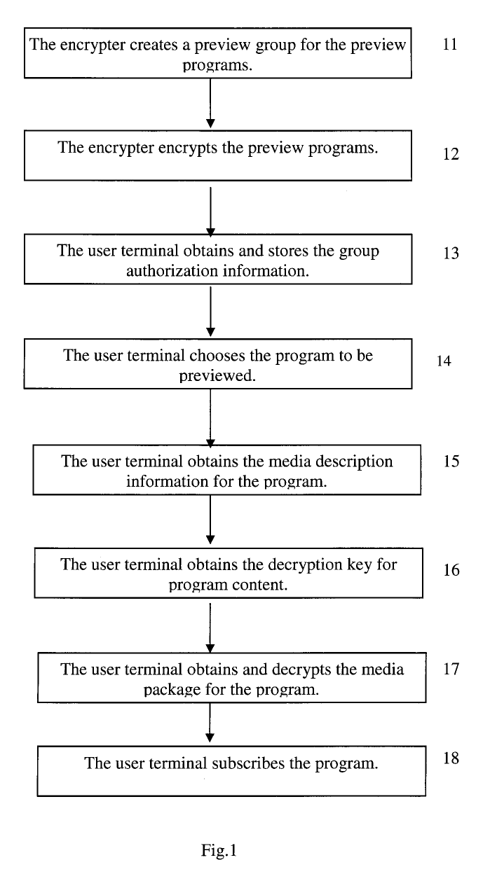

An embodiment of the method provided in the present invention is shown in FIG. 1, including the following steps:

Step 11: In a DRM system, an encrypt machine creates multiple preview groups for the preview programs according to different preview rules, and assigns a Group ID, a Group Encrypt Key (GEK) or a GEK obtaining ways, and a preview rule to each preview group.

After the encrypt machine has created the preview groups, it notifies the right center of information, such as the Group ID, the GEK or GEK obtaining ways, the preview rule, etc. corresponding to each preview group. The right center stores the above information.

The preview rule is a restriction on watching a preview program by a terminal, and preview programs can be divided according to the restrictions of accumulated time of preview which is permitted, permitted number of previews or the validity period, etc. In this way, each preview program can be assigned to a corresponding preview group according to its preview rule, and each preview group includes one or more preview programs with the same preview rule.

Step 12: When preview is permitted for a program, the program is encrypted.

In the present invention, two-level encryption processing is required in the program, that is, the program content is encrypted, and then the CEK or the CEK generation seed for the program is encrypted. The two encryption processes can be done in succession or separately.

The content encryption process for a program to be previewed is: a CEK or a CEK generation seed and a signature key for the program are determined, and the media package of the program is encrypted with the CEK in accordance with a symmetric cryptographic algorithm. Since the symmetric cryptographic algorithm is used, the decryption key for the program is the CEK or the CEK generation seed for the program, and the decryption algorithm is the corresponding encryption algorithm.

The information of the encrypted CEK or the CEK generation seed and the signature key for the preview program is carried in the ISMACrypKey which is in the media description information for the program (for SDP protocol, the SDP file is taken).

The encryption process that the information of encrypted CEK or the CEK generation seed and the signature key for the preview program is carried in ISMACrypKey in the program description information is hereinafter described in detail.

First, the encrypt machine determines the CEK or the CEK generation seed and the signature key for the preview program. Next, the encrypt machine chooses a corresponding preview group from the existing preview groups according to the preview rule of the program, and obtains the Group ID and GEK of the preview group. Finally, the encrypt machine defines parameters of Group ID and Content Key in ISMACrypKey which is in the media description information of the group. The value of the parameter Group ID is a Group ID of a preview group corresponding to the program; the content of the parameter Content Key is an encrypted and encoded value of the CEK or the CEK generation seed and the signature key for the program, for example, the CEK or the CEK generation seed and the signature key for the program is concatenated first; then, the concatenated content is encrypted with the GEK of the preview group by using a symmetric cryptographic algorithm; next the encrypted value is encoded and the encoded value is loaded into the parameter Content Key.

Since a symmetric cryptographic algorithm is used, the decryption key of the CEK or the CEK generation seed and the signature key for the program is the Group Encrypt Key (GEK) for the corresponding preview group, and the decryption algorithm is the corresponding encryption algorithm.

For example, the format of ISMACrypKey can be as follows:

ISMACrypKey=(URL)http://10.164.22.58:6080/ri/servletcontentissuer?ContentID=019 ba4422a285ebd;&GroupID=001;&ContentKey=:base64:YXVkcwAAEACAAACqADibcfgS erik7TpMjwF1hnXW5IcAAAAAAAAAAAAAAACBn

The Unique Resource Link (URL) in ISMACrypKey refers to an address to which the subscription request is sent after a user confirms to subscribe to a program.

In addition, when an encrypt machine encrypts the program content, an additional segment is generated for a media package of the program, and a current stage identification for the program and control information are configured in the additional segment according to the preview rule. At the same time, a digest is calculated for the additional segment and the digest is signed with the signature key, the signature being carried in the additional segment. The stage identification includes: an identification for a program-previewable stage and an identification for a program-non-previewable stage.

In that way, the DRM system can control the terminal's decryption for the preview program content according to the stage identification. That is to say, if the stage identification is an identification for a program-previewable stage, the terminal is permitted to decrypt the preview program content; if the stage identification is an identification for a program-non-previewable stage, the terminal is not permitted to decrypt the preview program content.

The control information is a restriction condition for decrypting a message by a terminal, for example, an adult classification restriction, or a password is required for restricted content, etc. When a terminal meets the restriction condition of the control information, the terminal is permitted to decrypt the preview program content, otherwise the terminal is not permitted to decrypt the preview program content.

Step 13: The terminal obtains the group authorization information and stores the group authorization information.

After the terminal finishes registration with the right center, it requests, in accordance with the Electronic Program Guide (EPG) notification and the locally stored group authorization information, the right center to dispatch the group authorization information of the preview group.

According to the terminal's request, the information corresponding to the related preview group stored by the right center, and the terminal information, the right center generates the corresponding group authorization information and dispatches the group authorization information to the terminal. The terminal receives and stores the group authorization information dispatched from the right center.

The group authorization information includes: a Group ID of the corresponding preview group, a decryption key (i.e., Group Encrypt Key (GEK)) and decryption algorithm information (i.e., the corresponding encryption algorithm) for the CEK or the CEK generation seed of the program in the preview group, a preview rule, and information of the terminal that requests for the group authorization information. The decryption algorithm information is, for example, the decryption algorithm identification.

The purpose of including the terminal information in the group authorization information is: only a terminal with the specific terminal information can decrypt a preview program with the group authorization information, so as to prevent adverse effect on the operator resulted from interception of the group authorization information.

When a terminal obtains the group authorization information, it obtains the entitlement for previewing all programs in the preview group corresponding to the group authorization information. Therefore, when the terminal chooses a preview program from the preview group corresponding to the group authorization information later, the dispatching of the corresponding group authorization information needs not to be performed again. In this way, not only concurrent traffic of visits to the right center is reduced and the system reliability is enhanced, but also the number of requesting the right center to dispatch the preview right by a terminal is reduced, and thereby the waiting time is shortened for the users. Furthermore, the operator can sell multiple programs with the same preview rule in a package.

Step 14: The terminal chooses a preview program.

The terminal obtains a list of programs from the EPG, the list containing the information of the programs' URLs, the right center's URL, and/or the previewable identification, etc. When the program list contains a previewable identification, it indicates the program can be previewed.

When the terminal chooses a program from the list of programs, if the terminal has not subscribed to the program and the program is previewable, prompt of preview or subscription will appear on the interface. When the terminal chooses the preview option, the process goes to step 15.

Step 15: The terminal obtains the media description information of the preview program from the MDN.

Step 16: The terminal utilizes the media description information to obtain the decryption key for the preview program.

According to the value of parameter Group ID in ISMACrypKey which is in the obtained media description information of the program, the terminal searches for the stored group authorization information. If the group authorization information corresponding to the preview program exists, the terminal obtains the decryption key and decryption algorithm identification information for parameter Content Key in ISMACrypKey, the decryption key being a GEK for the preview group corresponding to the preview program, and the decryption algorithm being the corresponding encryption algorithm, then, the terminal decrypts the parameter Content Key according to the GEK and the decryption algorithm information, to obtain the CEK or the CEK generation seed for the preview program, i.e., the decryption key and signature key for the program content. If the group authorization information corresponding to the preview program does not exist, the terminal requests the right center to dispatch the corresponding group authorization information according to the parameter Group ID in ISMACrypKey which is in the description information of the program. According to the terminal's request, the right center generates the corresponding group authorization information and dispatches the group authorization information to the terminal. The terminal stores the received group authorization information and obtains the decryption key GEK and decryption algorithm information for parameter Content Key. The terminal decrypts the parameter Content Key according to the GEK and the decryption algorithm information, to obtain the information of the CEK or the CEK generation seed for the preview program, i.e., the decryption key and signature key for the program content.

Step 17: The terminal establishes a connection to a media server, receives the media package of the program, and performs authentication, signature and decryption.

First, the terminal performs integrity verification for the stage identification and the control information in the additional segment according to the signature key. After the integrity verification is passed, if the stage identification in the additional segment in the media package received by the terminal is an identification for a program-previewable stage for the program and the terminal satisfies the control information in the additional segment, the DRM Agent in the terminal decrypts the media package by using the obtained CEK or the CEK generation seed for the program and plays the program with a media player, so as to implement program preview.

Step 18: The terminal subscribes to the preview program.

If the stage identification in the additional segment in the media package received by the terminal is an identification for a program-non-previewable stage for the program or the terminal does not satisfy the control information in the additional segment, the DRM Agent searches the terminal to determine whether there is a program right in the terminal, according to the Content ID in ISMACrypKey which is in the media description information of the program. If there is no program right in the terminal, the media player stops rendering the media package temporally and enquires whether to subscribe. If choosing to subscribe, the terminal initiates a subscription request to the right center according to the URL in ISMACrypKey which is in the media description information of the program. After obtaining the program right, the terminal obtains a CEK and a right rule of the program from the right and establishes a decryption environment. The media player continues to play the media package and the DRM Agent also continues to receive the encrypted media package. After that, the media package is decrypted according to the CEK or the CEK generation seed for the program and the program is played normally.

If the terminal chooses not to subscribe to the program, the reception of the media package is stopped.

Another embodiment of the present invention is: An encrypt machine loads the information of encrypted the CEK or the CEK generation seed for a preview program to the additional segment of a media package for the program (it is RTP message, if RTP protocol is taken) and dispatches the encrypted information to the terminal. In this way, each message only has one key, so that the system reliability is enhanced. The terminal obtains a decryption key for the program content from each additional segment of the media package to decrypt the media package.

To sum up, with the method described in the present invention, batch programs may be pre-authorized. Therefore, not only the concurrent traffic of visits to the right center is reduced and system reliability is enhanced, but also the number of requesting the right center to dispatch preview right is reduced, thereby the waiting time for the users is reduced and the users' experience is improved. Furthermore, configurable preview rules provide a flexible service operation means to the operator.

An encryption apparatus for implementing preview of IPTV programs provided in the present invention includes: a storage module and an encryption module. The right center provided in the present invention is equipped with a group authorization device.

The storage module is mainly configured to store preview groups, each preview group corresponding to at least one preview program. The preview programs can be divided into multiple preview groups according to the preview rules. Each preview group has a Group ID and each Group ID identifies a preview group uniquely. Each preview group has a group encrypt key (GEK) or GEK obtaining ways. The storage module is provided to submit the preview group information to the group authorization device.

The encryption module is mainly configured to dispatch an encrypted preview program to the terminal, i.e., the encryption module determines the CEK or the CEK generation seed and the signature key for a preview program to be dispatched and encrypts the media package of the program by using the CEK and a symmetric cryptographic algorithm. Since a symmetric cryptographic algorithm is used, the decryption key for the program content is the CEK or the CEK generation seed for that program, and the decryption algorithm is the corresponding encryption algorithm. When encrypting the preview program content, the encryption module generates an additional segment for the media package of the program, and sets a current stage identification for the preview program and control information of the additional segment according to the preview rule of the preview program. Then the encryption module calculates a digest for the additional segment and signs the digest with the signature key, the signature being added to the additional segment. The stage identification includes an identification for a program-previewable stage and an identification for a program-non-previewable stage, the control information is a restriction condition on decrypting a media package by the terminal. The encryption module encrypts a preview program through the process described in above method.

In addition, the encryption module also encrypts the CEK or the CEK generation seed and the signature key for the preview program. The encrypted information may be carried in ISMACrypKey in the media description information (it is SDP file, if SDP protocol is taken) of the program.

The group authorization device is mainly configured to generate group authorization information for terminals according to the preview group information submitted by a storage module after receiving the group authorization request from the user terminals. The group authorization information includes: a Group ID of the preview group, a preview rule, a decryption key or decryption key obtaining ways for the CEK or the CEK generation seed of the preview program, and decryption algorithm identification information, etc. When a symmetric cryptographic algorithm is used, the decryption key for the CEK or the CEK generation seed of the preview program is the GEK. The group authorization device dispatches the generated group authorization information to the terminals.

A user terminal device provided in the present invention has a key management module, a key obtaining module, and a decryption module.

The key management module is mainly configured to request the group authorization information from the right center. When a terminal finishes a registration with the right center, the key management module requests the right center to dispatch the group authorization information of the preview group that has not been stored by the terminal, according to the Electronic Program Guide (EPG) notification and receives, and stores the group authorization information dispatched from the right center.

When the terminal chooses a program from the list of programs, if the terminal has not subscribed to the program and the program is previewable, preview or subscription is prompted on the interface by the user terminal device. When the user terminal device chooses to preview, the user terminal device obtains the media description information of the preview program from the MDN. In accordance with the value of parameter Group ID in ISMACrypKey which is in the obtained media description information of the program, the key obtaining module requests the key management module to search for the stored group authorization information. If the key management module has stored the group authorization information corresponding to the preview program, the key obtaining module obtains the decryption key GEK and the decryption algorithm identification information for the parameter of Content Key in ISMACrypKey, the decryption key being the GEK for the preview group corresponding to the preview program, and the decryption algorithm being the corresponding encryption algorithm. The key obtaining module decrypts the parameter of Content Key according to the GEK and the decryption algorithm information, to obtain the CEK or the CEK generation seed and the signature key of the preview program. The key obtaining module sends the decryption key for decrypting the content and the signature key to the decryption module.

If the key management module does not store the group authorization information corresponding to the preview program, the key management module requests the right center to dispatch the corresponding group authorization information. After receiving the group authorization information from the right center, the key management module stores the group authorization information and notifies the key obtaining module. After receiving the notification from the key management module, the key obtaining module obtains the CEK or the CEK generation seed and the signature key for the preview program through the fore-mentioned process, and sends the decryption key for decrypting the content and the signature key to the decryption module.

Upon receiving the decryption key and signature key, the decryption module performs signature verification for the additional segment in the media package by using the signature key first. After the signature verification is passed, the decryption module obtains a current stage identification of the preview program and control information of additional segment from the additional segment in the media package. After it is determined that the stage identification is an identification for a program-previewable stage for the preview program and the terminal satisfies the control information in the additional segment, the decryption module decrypts the preview program according to the received decryption key, so as to implement program preview. When it is determined that the stage identification is an identification for a program-non-previewable stage for the preview program or the terminal does not meet the restriction condition of the control information in the additional segment, the decryption module searches for the terminal to determine whether there is a program right in the terminal according to the Content ID in ISMACrypKey which is in the media description information of the corresponding program. If there is no program right in the terminal, the rendering of the media packages is stopped temporally and whether to subscribe is enquired. If choosing to subscribe to the program, the user terminal device initiates a subscription request to the right center according to the URL in ISMACrypKey in the media description information of the program. After obtaining the program right, the terminal obtains a CEK and a right rule of the program from the right and establishes a decryption environment. The media player continues to play the media package and the decryption module also continues to receive the encrypted media package. After that, the media package is decrypted according to the CEK or the CEK generation seed for the program and the program is played normally. If the user terminal chooses not to subscribe to the program, the reception of the media package is stopped.

While the present invention has been illustrated and described with reference to some preferred embodiments, the present invention is not limited to these. Those skilled in the art should recognize that various variations and modifications can be made without departing from the spirit and scope of the present invention as defined by the accompanying claims.

1. A method for implementing preview of IPTV programs, comprising:
configuring at least one preview group in a Digital Right Management (DRM) system, each preview group corresponding to at least one preview program;
generating, by the DRM system, group authorization information for a terminal according to the preview group, and dispatching the group authorization information to the terminal;
obtaining, by the terminal, a Content Encrypt Key (CEK) or a CEK generation seed for a preview program chosen by the terminal in the corresponding preview group according to the received group authorization information and the media description information of the preview program, and decrypting the preview program chosen by the terminal to implement program preview.

2. The method according to claim 1, further comprising:
encrypting the preview program content;
encrypting the CEK or the CEK generation seed for the preview program.

3. The method according to claim 2, wherein encrypting the preview program content comprises:
determining a CEK or a CEK generation seed and a signature key for the preview program;
encrypting the media package of the program with the CEK in accordance with a symmetric cryptographic algorithm.

4. The method according to claim 2, wherein the preview group is configured according to a preview rule and has a corresponding Group Encrypt Key (GEK) or GEK obtaining means; encrypting the CEK or the CEK generation seed for the preview program comprises:
encrypting, by utilizing the GEK, the CEK or the CEK generation seed and a signature key for the preview programs in the preview group.

5. The method according to claim 4, wherein the encryption algorithm for encrypting the CEK or the CEK generation seed and the signature key for the preview programs in the preview group is the symmetric cryptographic algorithm, the decryption key for decrypting the CEK or the CEK generation seed for the preview programs in the preview group is the GEK of the preview group.

6. The method according to claim 4, wherein the information of the encrypted CEK or CEK generation seed and the signature key for the preview programs is carried in a content key parameter in the media description information for the preview programs or carried in an additional segment of the media package for the preview programs.

7. The method according to claim 1, wherein generating group authorization information for a terminal according to the preview group, and dispatching the group authorization information to the terminal comprise:
finishing, by a terminal, a registration in a right center;
determining that the group authorization information of the preview group is not stored in the terminal according to an Electronic Program Guide (EPG) notification;
requesting, by the terminal, the right center to dispatch the group authorization information of the preview group;
generating, by the right center, the corresponding group authorization information, and dispatching it to the terminal;
storing, by the terminal, the group authorization information.

8. The method according to claim 1, wherein generating group authorization information for a terminal according to the preview group, and dispatching the group authorization information to the terminal comprise:
choosing, by the terminal, a preview program;
determining that the group authorization information of the preview group which the preview program belongs to is not stored in the terminal;
requesting, by the terminal, the right center to dispatch the corresponding group authorization information, according to a Group ID of the preview group carried in the media description information of the program;
generating, by the right center, the corresponding group authorization information, and dispatching it to the terminal; and
storing, by the terminal, the group authorization information.

9. The method according to claim 1, wherein the group authorization information comprises:
a Group ID of the preview group, a preview rule, a decryption key for the CEK or a CEK generation seed of a preview program or a decryption key obtaining method, and decryption algorithm information.

10. The method according to claim 9, wherein the process of decrypting the preview programs to implement program preview comprises:
choosing, by the terminal, a preview program in the preview group;
determining, by the terminal, the corresponding group authorization information stored in the terminal according to the Group ID;
obtaining a decryption key and decryption algorithm information for the CEK or the CEK generation seed of the preview program according to the group authorization information;
decrypting, by the terminal, the encrypted CEK or the CEK generation seed according to the obtained decryption key and decryption algorithm information, to obtain the CEK or the CEK generation seed for the preview program;
decrypting each media package of the preview program, according to the obtained CEK or the CEK generation seed of the preview program, so as to implement program preview.

11. The method according to claim 10, wherein the Group ID is carried in the media description information of the program which is dispatched by a media server.

12. The method according to claim 3, further comprising:
generating an additional segment for the media package of the preview program;
setting, in the additional segment, a stage identification of the preview program and control information of the additional segment according to a preview rule of the preview program.

13. The method according to claim 12, wherein the stage identification comprises an identification for a program-previewable stage or an identification for a program-non-previewable stage, the control information being a restriction condition on decrypting a media package by a terminal;
and the processes for implementing the program preview comprise:
determining to permit the terminal to preview a program according to the stage identification and the control information in the additional segment;
decrypting, the media package of the preview program, by utilizing the CEK or the CEK generation seed for the preview program, so as to implement program preview.

14. The method according to claim 12, comprising:
verifying, by the terminal, integrity of the stage identification and the control information in the additional segment, according to a signature key in the media description information of the preview program.

15. The method according to claim 12, further comprising:
if the stage identification carried in the additional segment of the media package for the preview program is an identification for a program-non-previewable stage, implementing, by the terminal, the program subscription.

16. The method according to claim 1, wherein the media description information of the preview program comprises a parameter Group ID which is a Group ID of a preview group corresponding to the program and a parameter Content Key which is an encrypted and encoded value of the CEK or the CEK generation seed and the signature key for the preview program.

17. An encryption apparatus for implementing preview of IPTV programs, comprising:
a storage module, configured to store at least one preview group, each preview group corresponding to at least one preview program and a Group Encryption Key (GEK) or GEK obtaining ways;
an encryption module, configured to encrypt a preview program by utilizing a CEK of the preview programs and encrypt a CEK or CEK generation seed for each of the preview programs in a preview group by utilizing the GEK.

18. The encryption apparatus according to claim 17, further comprising:
a dispatching module, configured to dispatch the encrypted preview program and the encrypted CEK or CEK generation seed to a terminal.

19. The encryption apparatus according to claim 18, wherein the dispatching module is adapted to dispatch the encrypted preview program and the encrypted CEK or CEK generation seed in media description information or media package of the preview program to the terminal.

20. The encryption apparatus according to claim 17, wherein the encryption module is adapted to create an additional segment for a media package of a preview program, and set, in the additional segment, the current stage identification of the preview program and the control information of the additional segment, according to a preview rule of the preview program;
the stage identification comprises an identification for a program-previewable stage or an identification for a program-non-previewable stage and the control information is a restriction condition on decrypting a media package by a terminal.

21. A right center system, comprising a group authorization device,
the group authorization device is configured to generate group authorization information for a preview group and dispatch the group authorization information to the terminal.

22. A user terminal, comprising:
a key obtaining module for obtaining a Content Encryption Key (CEK) or a CEK generation seed for a preview program chosen by a terminal from a corresponding preview group according to group authorization information received by the terminal, and transmitting the CEK or CEK generation seed to a decryption module;
a decryption module for decrypting the preview program chosen by a user terminal according to the received CEK or the CEK generation seed, so as to implement program preview.

23. The user terminal device according to claim 22, wherein the user terminal device is further arranged with a key management module;
the key management module is configured to request, according to an Electronic Program Guide (EPG) notification, a right center to dispatch the group authorization information of the preview group that has not been stored by the terminal after the terminal finished a registration with the right center, and receive and store the group authorization information dispatched from the right center; or, after the terminal chooses a preview program and has not stored the group authorization information of the preview group which the program belongs to, the key management module requests the right center to dispatch the corresponding group authorization information according to a Group ID of the preview group carried in the media description information of the program, and receives and stores the group authorization information dispatched from the right center.

24. The user terminal of claim 22, further comprising a DRM agent,
the DRM agent is configured to decrypt each media package of the preview program, according to the obtained CEK or the CEK generation seed of the preview program, so as to implement program preview.

25. A method for implementing preview of IPTV programs, comprising:
configuring at least one preview group in a Digital Right Management (DRM) system, each preview group corresponding to at least one preview program;
generating, by the DRM system, group authorization information for a terminal according to the preview group, and
dispatching the group authorization information to the terminal to implement program preview.

26. The method of claim 25, further comprising:
encrypting the preview program content;
encrypting the CEK or the CEK generation seed for the preview program.

27. The method according to claim 25, wherein encrypting the preview program content comprises:
determining a CEK or a CEK generation seed and a signature key for the preview program;
encrypting the media package of the program with the CEK in accordance with a symmetric cryptographic algorithm.

28. The method according to claim 25, wherein the preview group is configured according to a preview rule and has a corresponding Group Encrypt Key (GEK) or GEK obtaining means; the encrypting the CEK or the CEK generation seed for the preview program comprising:
encrypting, by utilizing the GEK, the CEK or the CEK generation seed and a signature key for the preview programs in the preview group.

29. A method for implementing preview of IPTV programs, comprising:
receiving, by the terminal, group authorization information corresponding to a preview group from a DRM system;
obtaining a Content Encrypt Key (CEK) or a CEK generation seed for a preview program chosen by the terminal in the corresponding preview group according to the received group authorization information;
decrypting the chosen programs to implement program preview.

30. The method of claim 29, wherein the receiving, by the terminal, group authorization information corresponding to a preview group from a DRM system comprises:
choosing a preview program;
determining that the group authorization information of the preview group which the preview program belongs to isn't stored in the terminal;
requesting the right center to dispatch the corresponding group authorization information, according to a Group ID of the preview group;
receiving the group authorization information corresponding to a preview group from a DRM system.

31. The method according to claim 29, wherein the processes of decrypting the preview programs to implement program preview comprise:
choosing a preview program in the preview group;
determining the corresponding group authorization information stored in the terminal according to the Group ID of the preview group;
obtaining a decryption key and decryption algorithm information for the CEK or the CEK generation seed of the preview program;
decrypting the encrypted CEK or the CEK generation seed according to the obtained decryption key and decryption algorithm information, to obtain the CEK or the CEK generation seed for the preview program;
decrypting each media package of the preview program, according to the obtained CEK or the CEK generation seed of the preview program, so as to implement the program preview.
